(19) United States
(12) Patent Application Publication
(10) Pub. No.: US 2016/0028689 A1
(43) Pub. Date: Jan. 28, 2016

(54) Methods and system for controlling access to content using prior access information

(71) Applicant: David Charles Mendenhall, North Bay Village, FL (US)

(72) Inventor: David Charles Mendenhall, North Bay Village, FL (US)

(21) Appl. No.: 14/341,816

(22) Filed: Jul. 27, 2014

(51) Int. Cl. H04L 29/06

(52) U.S. Cl. CPC H04L 63/0209; H04L 63/10

(57) ABSTRACT

A device that intercepts requests to resources and information destined for the public Internet which uses a Uniform Resource Locator (URL) or resource address. As a result of this request, a transaction ensues to deliver content back to the requesting device. Within the response from the content resource, items like a referer (SIC) and other content can be used to make future decisions on the delivery of the content to the requesting device. This system specifically defines methods and processes to use a multitude of criteria delivered over the span of multiple requests to authorize, reject or modify the delivery of or the modification of the request for content thus changing the response delivered to the requesting devices.

### FIELD OF THE INVENTION

This invention uses the device requested information delivered over a multitude of requests to determine the continued validity of access to the content offered by the information source and delivered to the device requesting such information.

### BACKGROUND

Next Generation Firewall technology has become commonplace in today's networks. These devices generally allow or block content for a transaction between a client devices (heretofore a requesting device) and a content resource on the public Internet. Within this process the Firewall solution typically looks at a session of information and decides the best way to control that session.

Prior to Next Generation Firewall solutions controlling the data flowing in and out of a device to a resource, systems like Internet Proxies control the data flowing between a requesting device and the content resource. Proxies typically would control the access via an inspection of the connections and the URL requested. The proxy may also use the user name and other information based on the transaction for the allow or deny decision on a transaction.

A transaction of a single webpage, for example, can deliver a multitude of images and objects from other webpages within a single transaction and each object can be categorized differently and thus controlled. Today's solutions focus on the control of that page's content, whether delivered by the host site or another referenced location. The culmination of the delivered content and the decision whether to block or allow that content is based on logic processed within that single request.

The state of the art currently categorize a site defined by a list of URLs grouped into a finite list of content categories which provides a typical filtering process. The current art only process traffic that exists in the session and maximize overall efficiency, the state of the art solutions focus on content analysis on a single transaction and make an allow or block decision based on information within that session.

The researched embodiments of the present solutions, such as Intrusion Prevention Systems (IPS), next generation firewall solutions, proxy appliance systems, and other Internet Control Devices, uncovers the lack of use of extended context of a plurality of unique data requests over time to categorize and thus limit access to Internet Resources.

### SUMMARY OF THE INVENTION

This invention builds upon the current art in expanding the context of categorization of resources over time to build a unique response to requesting device over a multiple of requests to formulate an allow or blocking decision for the access of a resources on the public network.

In one embodiment, this invention intercepts the data flowing between a requesting device and the content on the public network and collects the Uniform Resource Locator (URL) information for the initial request. Like many other inventions currently published, this invention extracts the URL for a contextual categorization of the initial request. If this request is denied then no further processing is made and the request is logged into the user access database. If the requested content is allowed, then the transaction is marked as allowed and also logged. There is no difference between this process and other art in the marketplace. The new art in this invention pertains to subsequent access to resources in the public network which are evaluated based on the previous transactions made by the requesting device. The prior decisions made for a specific resource will influence current access restrictions and thus generate a unique allow or block decision based on the prior access results.

A further embodiment of the invention evaluates access of the requested resource by analyzing the context of a multitude of transactions from a multitude of content sources over a period of time to create a profile of access that allows or denies the utilization of a resource on a public network. This custom profile allows for future access unique to the individual device. In a sample use of this embodiment, the access to a search engine may change restriction patterns to enforce the search engine's Safe Search function if the requesting device has a searching pattern of restricted content occurs over a period time.

Once a threshold is met the system would enforce safe search by appending a safe search variable to the requested URL which is subsequently sent from the intermediary device to the search service. This threshold of search restriction may be imposed for a finite amount of time or number of search requests.

A further embodiment of the invention involves using “referer” (SIC), and heretofore known as referrer, and categorizes this referrer URL and maintains this information to make future URL access decisions. As a basis for the categories on a subsequent content requests both the referrer and the base URL are compared to a category list. System logic evaluates the requested resource by initially evaluating the requested URL which may will result in one of three results to either allowed, blocked or further analyzed the content. Further analysis will take the category of referrer URL. The resultant decision from the analysis of the category of the referrer will result in an allow, block or further analysis based on the legacy data collected from the requesting devices' previous access to public resource and content. A final decision on the content requested will be logged into the access data store for the requesting device.

### BRIEF DESCRIPTION OF THE DRAWINGS

FIG. 1 is a flow diagram for the interception, analysis, and initial categorization of the request from the requesting device to the responding resource as intercepted by the intermediary control point.

FIG. 2 is a flow diagram of the enhanced categorization and the use of additional information, such as referrer, for the decision whether to blocking or allow or further analyze the transaction.

FIG. 3 is a flow diagram using historical category in addition to the current request to create a custom modification to the URL being presented to the responding resource.

FIG. 4 is a flow diagram using historical application violation count along with additional information to modify the URL being presented to the content resource.

### DESCRIPTION OF THE PREFERRED EMBODIMENTS

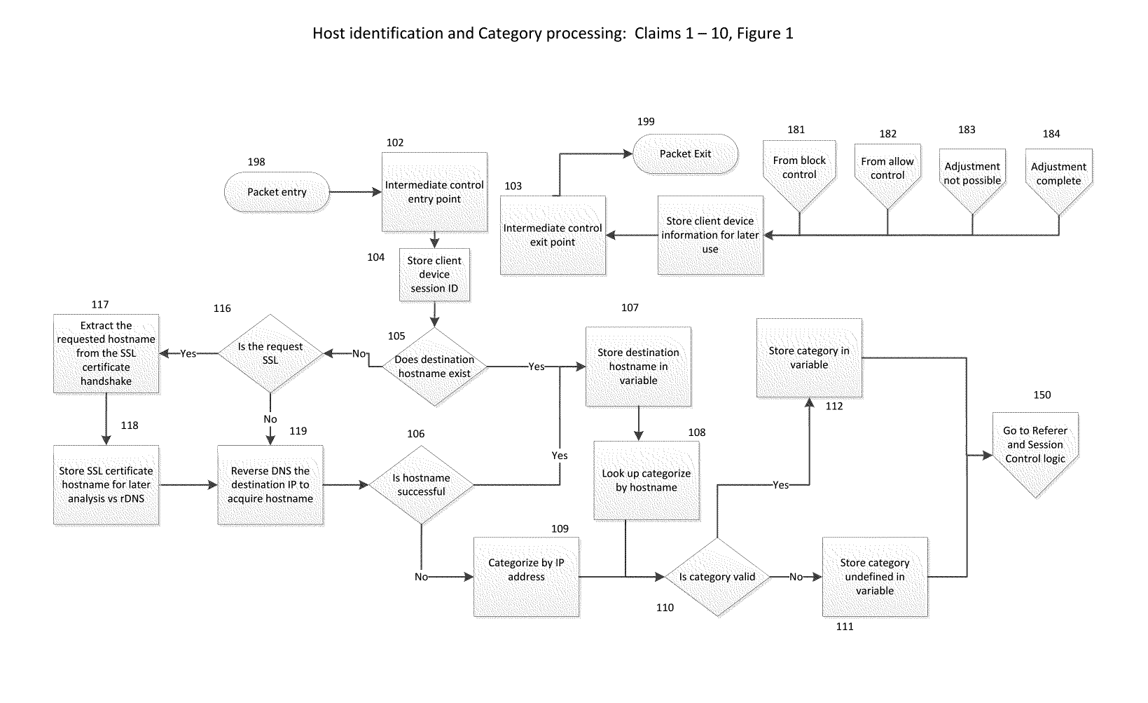

FIG. 1 shows the process by which a session is established between the requesting device and a content resource. The transaction begins with a packet stream being presented at the packet entry point 198, and being intercepted by the Intermediate control entry point device 102. Once the interception is started, the client device information is captured 104. As the destination is the decision point for most all actions in the device, a check of the destination host name 105 is evaluated. In certain cases the host name may be obfuscated by encryption. In this case, if the hostname is not easily extracted, a check for SSL encryption 116 will be attempted. Given the encryption test being affirmative, an extraction of the hostname from the SSL handshake process will be attempted 117. Once successful, the SSL common name hostname 118 will be stored and initially assumed as the destination hostname for categorization purposes. Given no SSL encryption or a successful extraction of the hostname from the SSL certificate, a reverse DNS action will be taken against the IP address for the hostname 119. The hostname result will be tested 106 for validity. If the hostname is accurate and valid 107, the hostname will be stored for later URL lookup processing.

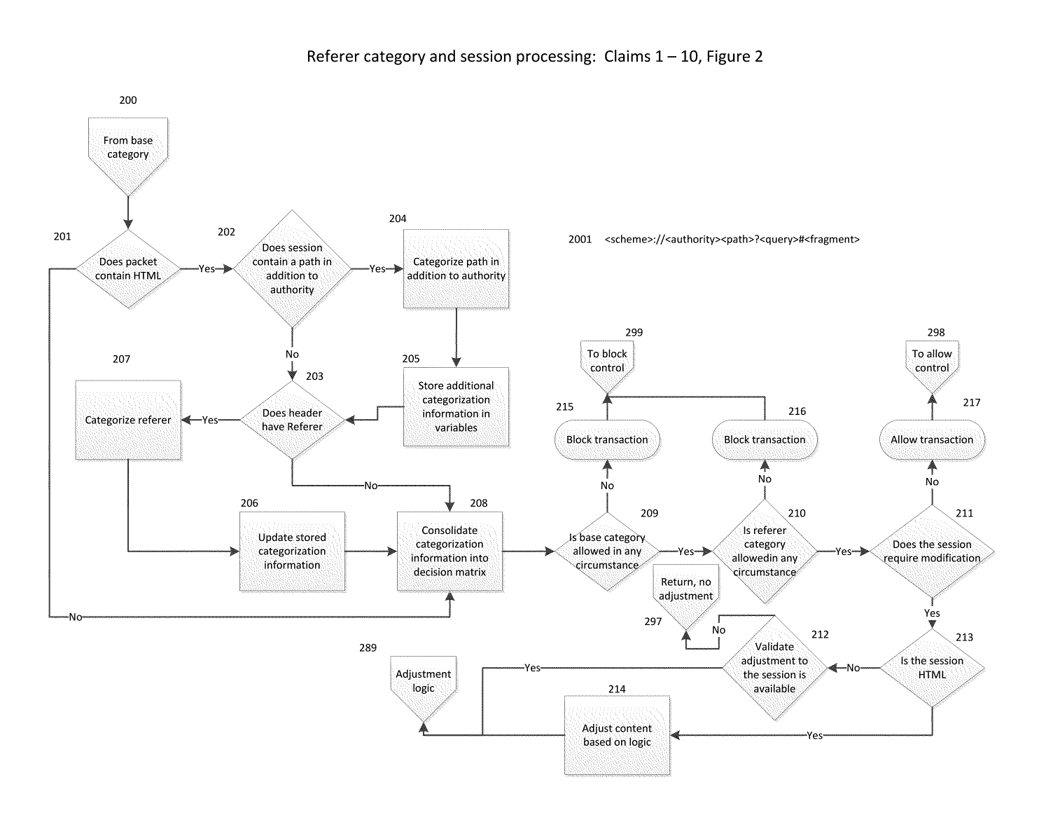

Categorization of the requested resource will be made using the hostname 108. If the hostname is invalid, request categorization will be attempted 109 using just the IP address. Finally, the validation of the assigned category or categories for this transaction is tested 110. If the category is valid, the category for the transaction is stored as a variable for later use 112 in making a block, allow, or continue examining the transaction. If the category is invalid, then the system stores that the category is not valid. Once the category, hostname, source identification and additional information relating to the current flow data is collected, it is passed 150 to the referrer category and session processing functions described in FIG. 2.

FIG. 2 shows the process by which the additional information required to provide additional logic to the categorization response to the request initiated by the requesting device. This enhanced logic begins with the entry of the data stream 200 and a validation of the flow containing HTML (Web) traffic 201. If there is not HTML in the request, then categorization will not take into consideration a referrer and will instead consolidate prior transactions from that requesting device 208 with the current category.

If the request is HTML and a URL 2001 is available, then additional specific categorization of the authority with a path is made 204 and then stored for further analysis 205. If the session does not contain a header or the path is already categorized, then a check is done for a referrer 203 within the header. If the referrer exists, then categorization of the referrer is performed 207 and the result is stored for later analysis 206. If no referrer is present or the referrer categorization is completed, then all data is consolidated into a matrix of current categories 208.

A check for the base category is performed 209 to validate it is allowed in any circumstance. If the base category is not allowed no matter the circumstance, a block 215 is performed on that object 299 and the response is sent back to the exit processing system 181. If the base category can be allowed under the correct conditions then the referrer category is validated. If the referrer category is to be blocked no matter the circumstance. 210 then a block is performed 216 and the response is sent back to the exit processing system 181.

If the referrer is allowed 210 then the system processes additional logic to modify the request 211. The request modification takes into consideration all factors collected throughout the data flow and consolidates a decision with respect to modification. If no modification is deemed required, the transaction is allowed 217 and returned 298 to the exit processing system 182.

If an adjustment to the transaction is required, then the session is checked for HTML 213 as adjustments to HTML is handled differently than other flows. If the flow is not HTLM then a validation of the session 212 is performed. If the session cannot be modified or does not need modification, then a response is sent 297 to the exit processing system 182. If the session is HTML, then the session is sent to the logic adjustment system 298.

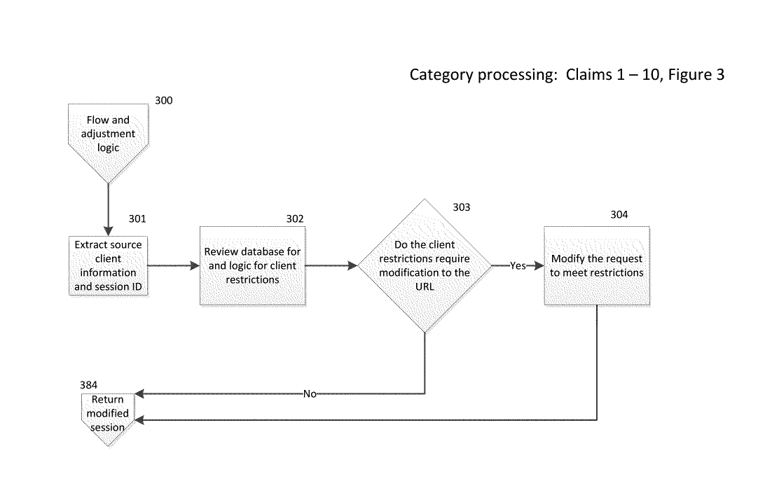

FIG. 3 shows the process by which a modification is applied to a specific flow using additional data collected with respect to the previous transactions by the requesting device. The request with the information previously determined enters 300 the process. After the entry, information from the source transaction is consolidated and made available to the logic systems 301. Once the data is consolidated, logic is applied 302 and client restriction decisions are formulated. If restrictions are required and a modification or a plurality of modifications is deemed needed 303 then a modification is undertaken 304. Once the modifications are completed or if there are no modifications needed, then the session is returned 384 to the exit processing system 182.

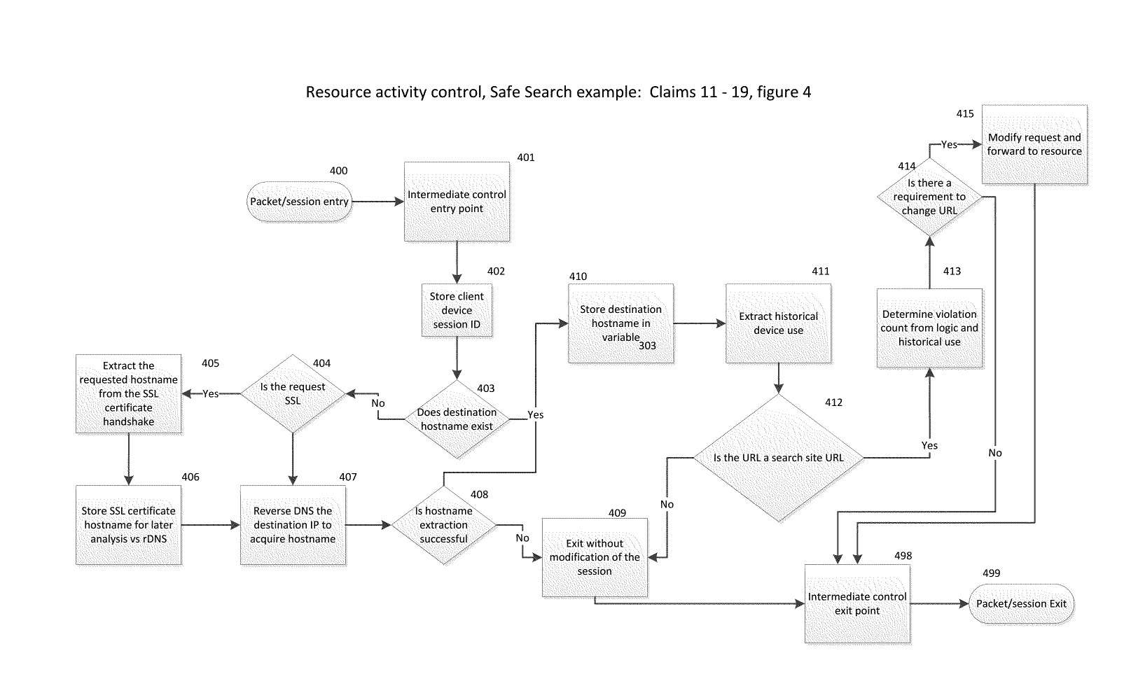

FIG. 4 shows the resource activity control process. The session enters the logic system 400 by the Intermediate control entry point system 401. The system stores the client 402 and requesting device information for later processing logic. As the destination is the decision point for most all actions in the device, a check of the destination host name 403 is evaluated. In certain cases the host name may be obfuscated by encryption. In this case, if the hostname is not easily extracted, a check for SSL encryption 404 will be attempted. Given the encryption test being affirmative, an extraction of the hostname from the SSL handshake process will be attempted 405. Once successful, the SSL common name hostname 406 will be stored and initially assumed as the destination hostname for categorization purposes. Given no SSL encryption or a successful extraction of the hostname from the SSL certificate, a reverse DNS action will be taken against the IP address for the hostname 407. The hostname result will be tested 408 for validity.

If the hostname is valid, the system stores the hostname variable 410 for later processing. The system extracts historical client and device used 411 and checks that the site is a modifiable request 412. With a valid modifiable request presented, determination of the use count will be performed 413 and based on logic 414 a determination if the request needs to be modified or allowed to continue unmodified. If a modification is required 415 it is processed. If a modification is not required or successful modification is completed, then 498 will be sent the modification result and prepare the session for use at the information source.

If the request is not able to be modified or if the hostname extraction failed then the session will exit unchanged 409 by sending the notification to the intermediate control exit point 498.

The intermediate control exit point 498 prepares the transaction for delivery and presents the session back onto the network 499 where it will continue to the content source server.

Classifications 713/154, 713/156, 713/160, 726/10, 726/11, 726/12

Patent Citations

| Cited Patent | Filing date | Publication date | Applicant | Title |
|---|---|---|---|---|
| U.S. Pat. No. | Aug. 18, 1995 | Aug. 24, 1999 | Microsoft Corporation | System and method for |
| 5,941,947 | | | | controlling access to data |
| | | | | entities in a computer |
| | | | | network |
| U.S. Pat. No. | Sep. 18, 1996 | Nov. 9, 1999 | Secure Computing | Secure firewall supporting |
| 5,983,350 | | | Corporation | different levels of |
| | | | | authentication based on |
| | | | | address or encryption |
| | | | | status |
| U.S. Pat. No. | Nov. 27, 2000 | Feb. 21, 2006 | 3Com Corporation | High performance IPSEC |
| 7,003,118 | | | | hardware accelerator for |
| | | | | packet classification |
| U.S. Pat. No. | Aug. 23, 2001 | Aug 29, 2006 | The Directtv Group, Inc. | Domain name system |
| 7,099,957 | | | | resolution |
| U.S. Pat. No. | Jan. 8, 1999 | Sep. 30, 2008 | International Business | Oblivious proxying using |
| 7,430,757 | | | Machines Corporation | a secure coprocessor |
| U.S. Pat. No. | Jun. 18, 2004 | Jun. 2, 2009 | Blue Coat Systems, Inc. | Using digital certificates to |
| 7,543,146 | | | | request client consent prior |
| | | | | to decrypting SSL |
| | | | | communications |
| U.S. Pat. No. | May 20, 2005 | Dec. 15, 2009 | Symantec Corporation | Validation of secure sockets |
| 7,634,811 | | | | layer communications |
| U.S. Pat. No. | Mar. 20, 2001 | Jul. 13, 2010 | Melih Abdulhayoglu | Methods of accessing and |
| 7,757,088 | | | | using web-pages |
| US20020194601 | Jul. 26, 2002 | Dec. 19, 2002 | Perkes Ronald M. | System, method and computer |
| | | | | program product for cross |
| | | | | technology monitoring, |
| | | | | profiling and predictive |
| | | | | caching in a peer to peer |
| | | | | broadcasting and viewing |
| | | | | framework |
| US20030014659 | Jul. 16, 2001 | Jan. 16, 2003 | Koninklijke Philips | Personalized filter for Web |
| | | | Electronics N.V. | browsing |
| US20040015725 | Jul. 24, 2002 | Jan. 22, 2004 | Dan Boneh | Client-side inspection and |
| | | | | processing of secure content |
| US20040068665 | Jan. 28, 2002 | Apr. 8, 2004 | Openwave Systems Inc. | Method and apparatus for |
| | | | | maintaining security in a |
| | | | | push server |
| US20050015594 | Jul. 17, 2003 | Jan. 20, 2005 | International Business | Method and system for |
| | | | Machines Corporation | stepping up to certificate- |
| | | | | based authentication |
| | | | | without breaking an |
| | | | | existing SSL session |
| US20050144297 | Dec. 30, 2003 | Jun. 30, 2005 | Kidsnet, Inc. | Method and apparatus for |
| | | | | providing content access |
| | | | | controls to access the |
| | | | | internet |
| US20070234414 | Apr. 23, 2007 | Oct. 4, 2007 | Huawei Technologies | Firewall control system |
| | | | Co., Ltd. | based on a next generation |
| | | | | network service and |
| | | | | method thereof |
| U.S. Pat. No. | Jan. 31, 2006 | Nov. 20, 2012 | Blue Coat Systems, Inc. | Methods and systems for |
| 8,316,429 | | | | obtaining URL filtering |
| | | | | information |
| US20130312054 | May 17, 2012 | Nov. 21, 2013 | Cisco Technology, | Transport Layer Security |
| | | | Inc. | Traffic Control Using Service |
| | | | | Name Identification |
| US20130347069 | Sep. 10, 2012 | Dec. 26, 2013 | Electronics And | Referer verification |
| | | | Telecommunications | apparatus and method |
| | | | Research Institute | |

1. A method, comprising:
Receiving by a requesting device at an intermediary control point, a request from a device requesting resource access;
Transmitting from said intermediate control point, a request for content from the information source;
Extracting, at the intermediary control point, information pertaining to the access request;

2. The method of claim 1, wherein a hostname is contained in the request.

3. The method of claim 1, categorizing, at the intermediary control point, the destination address defined in the request into a one or a plurality of available categories.

4. The method of claim 1, wherein categorizing, at the intermediary device, the destination address that resulted in the current destination: This address is typically called the referer (SIC).

5. The method of claim 4, wherein using the referer category and combining with the actual destination address category is used to determine the action for the resource requested: allow, block or to further evaluate prior to allowing or blocking, the requested content by the requesting device.

6. The method of claim 1, wherein access to categories by the device is collected and stored in a data storage system.

7. The method of claim 1, wherein the data collected from previous resource access activity is combined with the category of the requested resource to allow, block or further evaluate the request prior to allowing or blocking the requested content by the requesting device.

8. The method of claim 1, whereby the destination address at the intermediary control point comprises a hostname.

9. The method of claim 1, whereby in a secure socket layer (SSL) Connect process, the requested destination host information of the content source is extracted within the certificate exchange process.

10. The method of claim 1, whereby in the case of a block action results in a response sent to a requesting device as to close the connection and deny the access.

11. A method, comprising:
Receiving by a requesting device at an intermediate control point, the request for the source object;
Transmitting from said intermediate control point, a request for content from the information source;
Extracting, at the intermediary control point, information pertaining to the access request;

12. The method of claim 11, whereby based on previous resource access activity, the device requesting access to a resource is found to require a modification to the Uniform Resource Locator (URL) that was presented to the intermediate control point device.

13. The method of claim 12, whereby a modification of the requested content is applied to the request and the corresponding request from the intermediate control point is sent to the information source.

14. A method, comprising:
Receiving by a requesting device at an intermediate control point, the request for the source object;
Transmitting from said intermediate control point, a request for content from the information source;
Extracting, at the intermediary control point, information pertaining to the access request;

15. The method of claim 14, whereby the frequency of access impacts the result of access to allow, block or perform further evaluation of the response. Frequency of access to a specific resource as measured over access over time.

16. The method of claim 15, whereby the frequency of access is populated to the data store holding device statistics

17. The method of claim 14, whereby the frequency of use of a specific resource impacts the result of the access. The use of a resource as measured over time.

18. The method of claim 17, whereby the frequency of use is populated to the data store holding device statistics

19. The method of claim 14, evaluating the access and use stored in the data store holding device statistics results in the modification of the request to the information source or response to the requesting device for resource access.
